(19) United States
(12) Patent Application Publication
(10) Pub. No.: US 2025/0265775 A1
(43) Pub. Date: Aug. 21, 2025

(54) INFORMATION PROCESSING APPARATUS CONTROLLING STATE TRANSITION OF CONTENT DISPLAYED IN VIRTUAL SPACE, INFORMATION PROCESSING METHOD, AND STORAGE MEDIUM

(71) Applicant: CANON KABUSHIKI KAISHA, Tokyo (JP)

(72) Inventor: KOUSHI TAKEMURA, Kanagawa (JP)

(21) Appl. No.: 19/003,105

(22) Filed: Dec. 27, 2024

(30) Foreign Application Priority Data
Feb. 19, 2024 (JP) 2024-022785

(51) Int. Cl. G06T 17/00; A63F 13/52; G02B 27/01; G06F 3/01

(52) U.S. Cl. CPC G06T 17/00; A63F 13/52; G02B 27/017; G06F 3/013

(57) ABSTRACT

An information processing apparatus that enables a user to safely and comfortably experience content displayed in a virtual space. The information processing apparatus, which displays a virtual space on a head mounted display worn by a user, acquires a play area of the user as a first play area, detects an obstacle in a real space in the first play area and generates obstacle information indicating a positional relationship between the detected obstacle and the first play area, acquires user information from the user, executes state transition determination of determining whether content to be displayed in the virtual space can transition to a next state on basis of the obstacle information and the user information, and makes a notification according to a result of the state transition determination.

### BACKGROUND OF THE INVENTION

### Field of the Invention

The present invention relates to an information processing apparatus, an information processing method, and a storage medium, and particularly to an information processing system controlling state transition of content displayed in a virtual space, an information processing method, and a storage medium.

### Description of the Related Art

In recent years, a technology called virtual reality (VR) for experiencing immersion in a virtual space created by a computer different from reality has been widely used. There are many pieces of content, displayed in the virtual space, to which the VR technology is applied (hereinafter, VR content). For example, while a head mounted display (HMD) is worn on the head and a screen displayed on the HMD is viewed, a controller or the like is operated to play a game. When the HMD is worn in this way, the real world becomes invisible, and thus the user's sense of immersion in the virtual space increases. In VR content in which a remote user, a non player character (NPC), or the like is displayed in the HMD and a sports battle is played, the user wearing the HMD can also play a game in a play area set on the virtual space.

For example, Japanese Laid-Open Patent Publication (kokai) No. 2018-029968 discloses a technology in which, when a user wears an HMD and enjoys a virtual space, the HMD causes a game to transition to a primary stop state when receiving a game suspension signal, and then causes the game to transition to a restart state when receiving a game restart signal.

However, in the technology of Japanese Laid-Open Patent Publication (kokai) No. 2018-029968, since the state transition of the game is performed in response to reception of a signal such as the game suspension signal or the game restart signal, there is a problem in that the state transition of the game is performed in a state where the safety of the user is not secured.

### SUMMARY OF THE INVENTION

The present invention provides an information processing apparatus that enables a user to safely and comfortably experience content displayed in a virtual space, an information processing method, and a storage medium.

Accordingly, the present invention provides an information processing apparatus according to claim 1 displaying a virtual space on a head mounted display worn by a user, comprises one or more processors and/or circuitry configured to acquire a play area of the user as a first play area, detect an obstacle in a real space in the first play area and generate obstacle information indicating a positional relationship between the detected obstacle and the first play area, acquire user information from the user, execute state transition determination of determining whether content to be displayed in the virtual space can transition to a next state on basis of the obstacle information and the user information, and make a notification according to a result of the state transition determination.

Further features of the present invention will become apparent from the following description of exemplary embodiments (with reference to the attached drawings).

### BRIEF DESCRIPTION OF THE DRAWINGS

FIG. 1 is a diagram showing a hardware configuration example of an information processing apparatus according to a first embodiment of the present invention.

FIG. 2 is a block diagram showing a functional configuration according to the first embodiment of the present invention of the information processing apparatus.

FIG. 3 is a diagram showing an example of state transition control of VR content according to the first embodiment of the present invention.

FIG. 4 is a flowchart of state transition control processing of VR content according to the first embodiment of the present invention.

FIGS. 5A and 5B are diagrams showing variations of state transition control of VR content according to the first embodiment of the present invention.

FIGS. 6A to 6C are diagrams showing examples of HMD display according to the first embodiment of the present invention.

FIGS. 7A and 7B are diagrams showing examples of an obstacle and a play area in a three-dimensional space.

FIG. 8 is a block diagram showing a functional configuration according to a second embodiment of the present invention of the information processing apparatus.

FIG. 9 is a diagram showing an example of state transition control of VR content according to the second embodiment of the present invention.

FIG. 10 is a flowchart of state transition control processing of VR content according to the second embodiment of the present invention.

FIG. 11 is a diagram showing an example of HMD display according to the second embodiment of the present invention.

### DESCRIPTION OF THE EMBODIMENTS

The present invention will now be described in detail below with reference to the accompanying drawings showing embodiments thereof.

Hereinafter, embodiments according to the present invention will be described with reference to the drawings. The following embodiments do not limit the present invention, and not all combinations of features described in the present embodiments are essential to the solution of the present invention. The configuration of the embodiment can be appropriately modified or changed according to specifications of an apparatus to which the present invention is applied and various conditions (usage conditions, usage environment, etc.). Some of the embodiments described later may be appropriately combined. In the following embodiments, the same components are denoted by the same reference numerals.

### First Embodiment

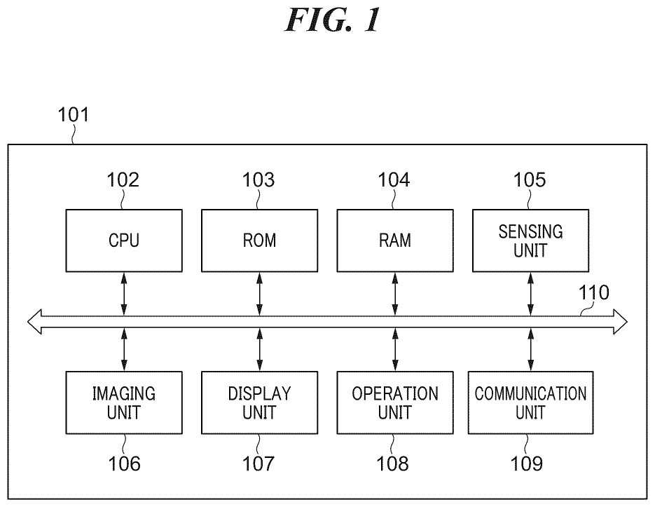

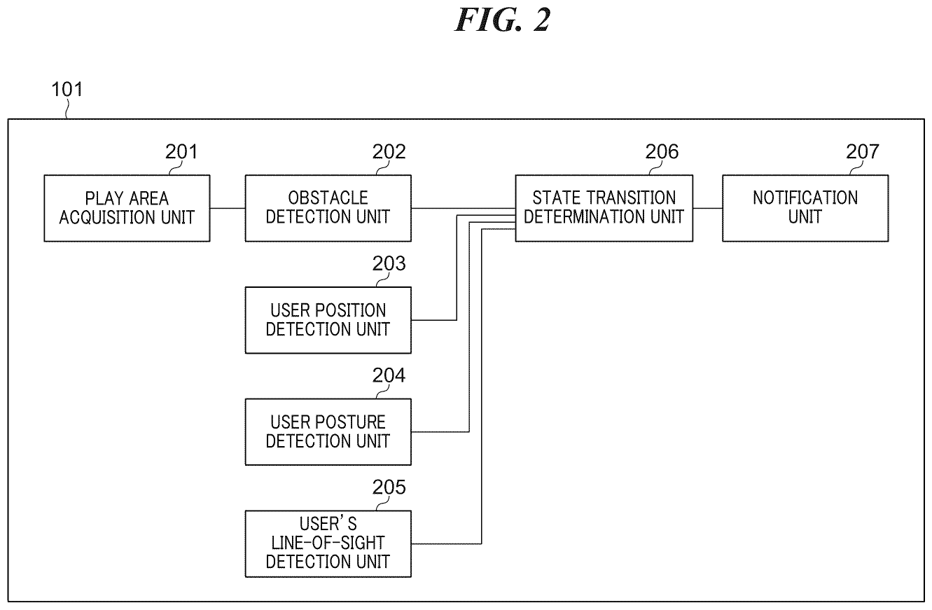

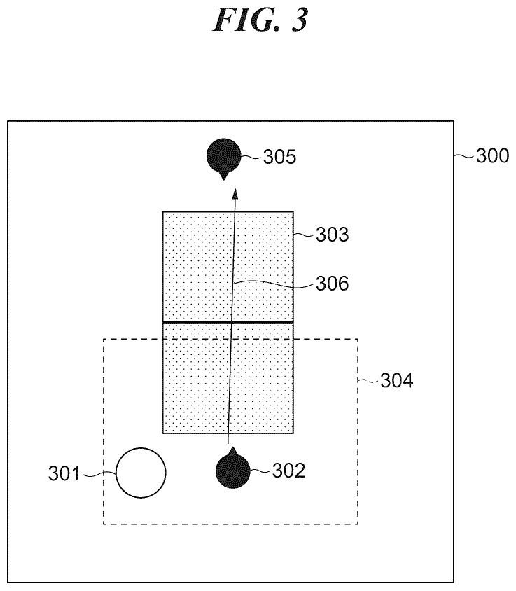

FIG. 1 is a block diagram showing a hardware configuration example of an information processing apparatus 101 according to a first embodiment of the present invention. FIG. 2 is a block diagram showing a functional configuration according to the first embodiment of the present invention of the information processing apparatus 101. FIG. 3 is a diagram showing an example of state transition control of VR content according to the first embodiment of the present invention. It should be noted that, here, content displayed in a virtual space is referred to as VR content.

First, an example of state transition control of VR content in the virtual space according to the present embodiment on the basis of the state of the real space and the state of the user will be described with reference to FIG. 3. Here, as an example, a scene in which the user plays VR table tennis at home will be described. However, the VR content to which the present invention is applied is not limited to VR table tennis as long as it is a scene in which battle type VR content (sports, game, training) is started at home or the like.

An image 300 in FIG. 3 is an image of the user viewed from above.

FIG. 3 shows a trash box 301 which is an obstacle in the real space, a user 302 who experiences VR content, a virtual table tennis table 303, a play area 304, an avatar 305 of an opponent, and a line-of-sight direction 306 of the user 302.

The play area 304 is a play area of the user 302, and the size thereof is defined in advance according to the type of VR content and the number of players. In FIG. 3, the play area 304 indicates a movement range of a user of a singles game in VR table tennis.

It should be noted that, although the user 302 cannot see the trash box 301 in the real space because the user 302 wears a head mounted display (HMD), the HMD worn by the user 302 has a function of acquiring position and orientation information of the trash box 301 and the user 302. Therefore, the HMD can obtain obstacle information indicating a positional relationship between the trash box 301 and the play area 304. The HMD can reflect the motion similar to the motion of the user 302 in the real space on an avatar in the virtual space.

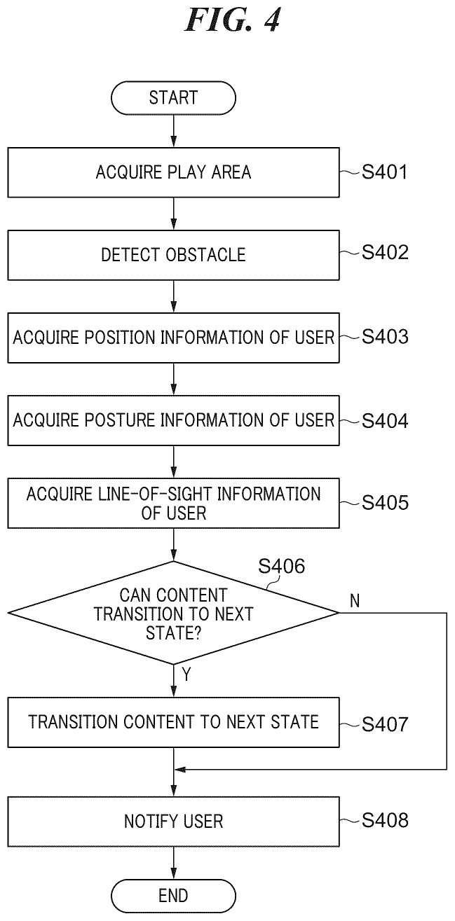

The information processing apparatus 101 (FIG. 1) determines whether or not to permit a state transition of VR content according to information (position, posture, line of sight, voice) of the user 302 and the obstacle information in the real space existing in the play area 304, which are acquired by the HMD, and displays the VR content on the HMD. Specifically, state transition control processing of VR content described later will be described with reference to the flowchart of FIG. 4.

In order to transition to a state in which the user 302 can start the VR content, it is necessary to confirm in advance whether the safety of the user 302 is secured or whether the preparation of the user 302 for starting the VR content is completed. However, since the user 302 wearing the HMD cannot see the real space, it is difficult for the user himself/herself to recognize the obstacle (trash box 301) in the real space during the VR content experience and then transition the state of the VR content next.

When the opponent is an NPC, there is a case where the NPC transitions the state of the VR content regardless of the state of the user 302 or the state of the real space, and in this case, the user 302 cannot comfortably experience the VR content.

When the user 302 starts the VR content in the state of FIG. 3, there is a possibility of coming in contact with the trash box 301 during game play since the trash box 301 exists in the play area 304. In the existing technology, when a text message is received or a person who is talking in the vicinity of the user 302 is detected, the game that is the VR content is interrupted, but the game is not interrupted according to the state of the user 302 or the state of an obstacle in the real space.

Therefore, in the present embodiment, the information processing apparatus 101 determines whether or not to permit a state transition of VR content from user information such as position information, posture information, and line-of-sight information of the user 302 who experiences the VR content and the obstacle information of the real space, and presents the VR content to the user 302. This enables the user 302 to safely and comfortably experience the VR content.

Next, the hardware configuration of the information processing apparatus 101 will be described with reference to FIG. 1.

The information processing apparatus 101 is an HMD worn by the user 302 and is connected to an external PC. However, the information processing apparatus 101 may be an electronic device capable of communicating with and controlling the HMD worn by the user 302, and may be, for example, an electronic device such as a PC to which the HMD is connected. The information processing apparatus 101 includes, as components, a CPU 102, a ROM 103, a RAM 104, a sensing unit 105, an imaging unit 106, a display unit 107, an operation unit 108, and a communication unit 109. The components are connected to each other via a bus 110.

The CPU 102 is an arithmetic processing apparatus that integrally controls the information processing apparatus 101. The CPU 102 executes various programs stored in the ROM 103 or the like to perform various processes.

The ROM 103 is a read-only nonvolatile memory device that stores programs (information processing programs, initial data, and the like) and parameters that do not need to be changed.

The RAM 104 temporarily stores input information, calculation results in information processing, and the like. The RAM 104 is a memory device that provides the CPU 102 with a work area.

The sensing unit 105 is a device such as a sensor, and detects the rotation, inclination, or movement amount of the head, and the line of sight of the user 302 wearing the information processing apparatus 101 that is an HMD, thereby acquiring the position and orientation information and the line-of-sight direction information of the user 302. The sensing unit 105 also includes a sound collecting device such as a microphone that acquires the voice of the user 302.

The imaging unit 106 is an imaging device which is a built-in camera of the information processing apparatus 101 that is an HMD, and performs imaging processing. It should be noted that, when the information processing apparatus 101 is a PC connected to the HMD worn by the user, an externally connected web camera or the like functions as the imaging unit 106.

The display unit 107 includes a liquid crystal display or the like, and displays a captured image, a virtual object, a character, an icon, or the like to the user wearing the information processing apparatus 101 that is an HMD.

The operation unit 108 is an operation unit including an operation member such as a power button or a dial.

The communication unit 109 transmits and receives data to and from an external device by wired communication or wireless communication (wireless LAN, local 5G, etc.). Examples of the external device include an external controller (not shown) held by the user wearing the information processing apparatus 101 that is an HMD, another HMD, and an external operation panel. It should be noted that, when the information processing apparatus 101 is a PC connected to the HMD worn by the user, the communication unit 109 receives position and orientation information and the like detected by the HMD via a network (not shown).

FIG. 2 is a block diagram showing a functional configuration according to the present embodiment of the information processing apparatus 101 that is an HMD (hereinafter, simply referred to as HMD 101).

The HMD 101 includes, as a functional configuration, a play area acquisition unit 201, an obstacle detection unit 202, a user position detection unit 203, a user posture detection unit 204, a user's line-of-sight detection unit 205, a state transition determination unit 206, and a notification unit 207.

The play area acquisition unit 201 acquires, from the ROM 103, information on a play area (first play area) for the user to experience VR content. The size of the play area is defined in advance according to the type of VR content and the number of players.

The obstacle detection unit 202 detects an obstacle in the real space in the play area and generates obstacle information indicating a positional relationship between the detected obstacle and the play area. There are various kinds of obstacles such as a wall, a chair, a desk, a trash box, a person, and a pet, but a method for specifying an obstacle is not described herein. It should be noted that the detection of the obstacle in the present embodiment may be detected by the imaging unit 106 that is a camera attached to the HMD 101, or may be detected using an external second camera via the communication unit 109. Alternatively, the detection may be performed using the sensing unit 105 that is a sensor.

The user position detection unit 203 acquires position information in the virtual space of the user wearing the HMD 101 by the sensing unit 105, and holds the position information as the position information of the user.

The user posture detection unit 204 acquires posture information in the virtual space of the user wearing the HMD 101 by the sensing unit 105, and holds the posture information as the posture information of the user.

The user's line-of-sight detection unit 205 acquires information of the line-of-sight direction in the virtual space of the user wearing the HMD 101 by the sensing unit 105, and holds the information.

The state transition determination unit 206 determines whether or not to transition the VR content state to the next state (state transition determination) according to the obstacle information generated by the obstacle detection unit 202 and the user information such as the position, posture, and line-of-sight direction of the user.

The notification unit 207 (notifying unit) displays, on the display unit 107, a notification screen corresponding to the result of the state transition determination in the state transition determination unit 206.

FIG. 4 is a flowchart of state transition control processing of VR content according to the present embodiment. The processing shown in this flowchart is realized by the CPU 102 reading a program stored in the ROM 103 into the RAM 104 and executing the program. The execution timing of this processing is not limited. For example, it may be a timing at which a user wearing the HMD 101 (hereinafter, simply referred to as a user) activates VR content, or may be executed when the operation unit 108 detects a predetermined user operation. Hereinafter, the VR table tennis will be described as an example in which the VR content is in an interrupted state and the user is in the play area at the start of the VR content.

First, in step S401, the play area acquisition unit 201 acquires information on the play area of the VR content currently interrupted from the ROM 103.

Next, in step S402, the obstacle detection unit 202 detects an obstacle in the real space in the play area on the basis of the information on the play area acquired in step S401. At this time, the notification unit 207 may notify the user to look around so that a wide area around the user can be searched. Thereafter, the obstacle detection unit 202 generates obstacle information indicating a positional relationship between the detected obstacle and the play area.

Next, in step S403, the user position detection unit 203 acquires position information of the user.

Next, in step S404, the user posture detection unit 204 acquires posture information of the user.

Next, in step S405, the user's line-of-sight detection unit 205 acquires information of the line-of-sight direction of the user (line-of-sight information).

It should be noted that the generation of the obstacle information and the acquisition of the position, posture, and line-of-sight information of the user in steps S402 to S405 may be performed after step S401 and before step S406 described later, and the execution order thereof is not limited to the order shown in FIG. 4.

Next, in step S406, the state transition determination unit 206 determines whether or not to permit a state transition of VR content on the basis of the obstacle information generated in step S402 and the position, posture, and line-of-sight information of the user acquired in steps S403 to S405. Specifically, when table tennis is played in the real space, the referee confirms whether the receiver is ready before resuming the interrupted game and starting a serve by hitting the ball held in the hand by the opponent on the server side, so a similar operation is performed in the VR environment. When it is determined that the state transition of the VR content cannot be performed (NO in step S406), the processing proceeds to step S408, and when it is determined that the state transition of the VR content can be performed (YES in step S406), the processing proceeds to step S407.

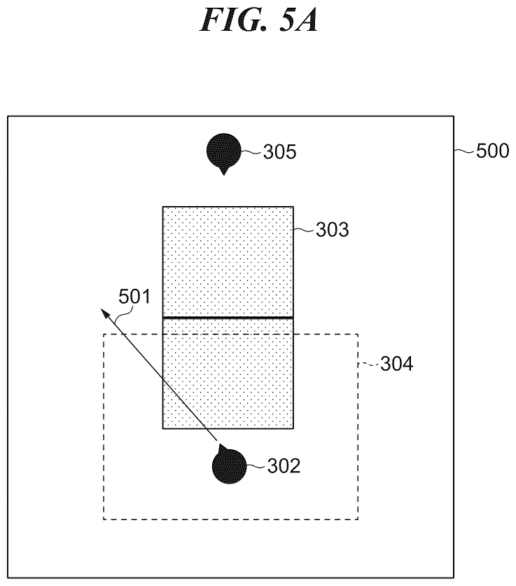

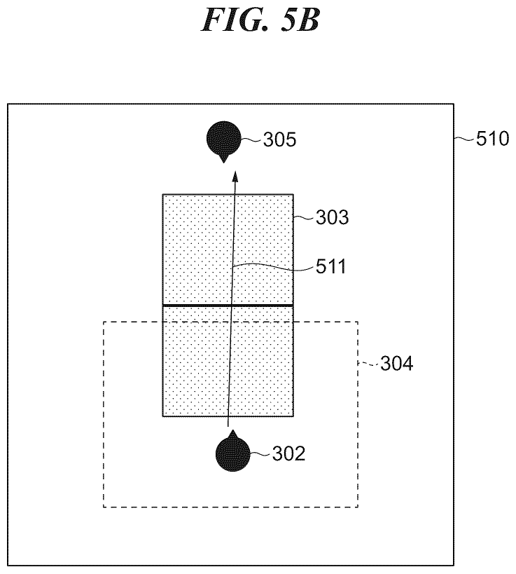

Here, a method for determining whether or not to permit a state transition of VR content according to the present embodiment will be described with reference to FIG. 3 and FIGS. 5A and 5B. Each of the image 300 of FIG. 3, an image 500 of FIG. 5A, and an image 510 of FIG. 5B is an image of the user viewed from above.

Here, as shown in FIG. 3, when the trash box 301 exists in the play area 304, the user 302 may collide with the trash box 301 during the game. In such a case, in order to avoid a collision between the user 302 and the trash box 301, the state transition determination unit 206 determines that the state transition of the VR content cannot be performed, that is, maintains the current suspension state and does not transition to the play state.

FIGS. 5A and 5B are diagrams for explaining a method for determining whether or not to permit a state transition of VR content on the basis of the obstacle information generated in step S402 and the line-of-sight direction information of the user 302 acquired in step S405.

In the image 500 in FIG. 5A, there is no obstacle in the real space in the play area 304, but a line-of-sight direction 501 of the user 302 does not face the direction of the avatar 305 of the opponent. Therefore, the state transition determination unit 206 determines that the state transition of the VR content cannot be performed, that is, maintains the current suspension state and does not transition to the play state.

On the other hand, in the image 510 in FIG. 5B, there is no obstacle in the real space in the play area 304, and a line-of-sight direction 511 of the user 302 faces the direction of the avatar 305 of the opponent. Therefore, the state transition determination unit 206 determines that the state of the VR content can transition, that is, the state transitions from the current suspension state to the play state.

It should be noted that, in the present embodiment, when an angle formed by the line-of-sight direction of the user acquired in step S405 and the direction of the avatar of the opponent viewed from the user in the virtual space is a predetermined angle or less, it is determined that the line of sight of the user is directed to the avatar of the opponent. On the other hand, when the angle formed by the line-of-sight direction of the user and the direction of the avatar of the opponent viewed from the user in the virtual space is larger than the predetermined angle, it is determined that the line of sight of the user is not directed to the avatar of the opponent.

In the present embodiment, the line-of-sight direction of the user to the opponent is used to determine whether or not to permit a state transition, but the present invention is not limited thereto. The line-of-sight direction of the user used to determine whether or not to permit the state transition may be able to be designated for each VR content, or may be able to be set according to the type and the number of opponents. A gaze time may be used in addition to the line-of-sight direction of the user. The target to which the line of sight of the user is directed may be a target designated in advance. For example, the target may be a predetermined area in the virtual space instead of the avatar of the opponent.

Even when the user does not exist in the play area or when either the position or the posture of the user is not stationary in the play area, it may be determined that the user is not ready and the state of the VR content cannot transition.

Further, when the user does not conform to a posture specified in advance, for example, a form of a reception in table tennis, or the like, it may be determined that the user is not ready and the state of the VR content cannot transition.

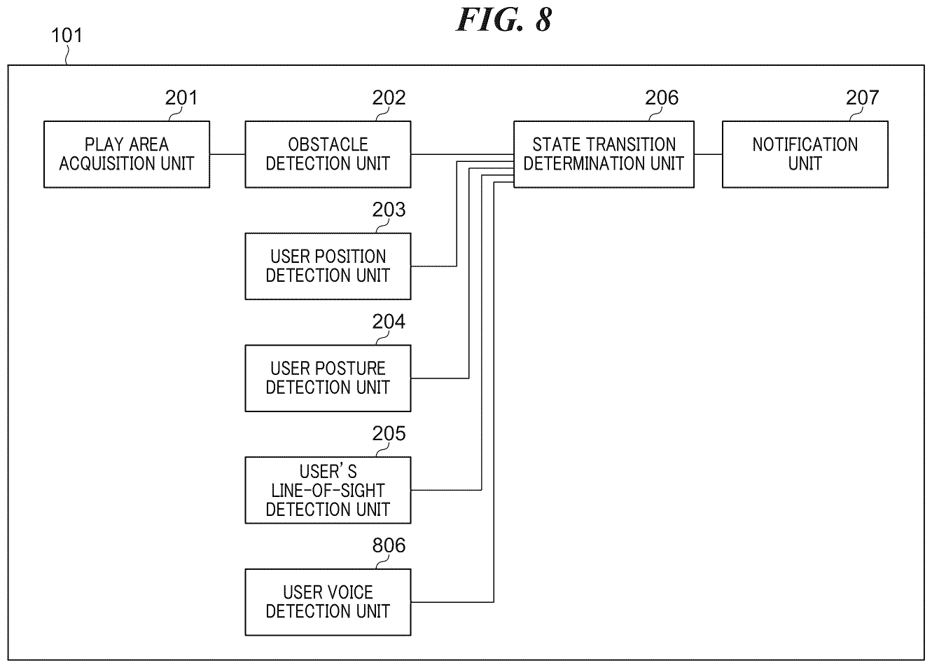

The information processing apparatus 101 may include a user voice detection unit (FIG. 8) described later. In this case, when there is utterance of a word specified in advance by the user, for example, “WAIT!”, it may be determined that the state of the VR content cannot transition since the user is not ready.

That is, when it is determined that there is no obstacle in the play area 304 and the preparation of the user is ready on basis of at least one of the position, line of sight, posture, and voice of the user, the state transition determination unit 206 determines that the state of the VR content can transition.

Next, in step S407, the state transition determination unit 206 transitions the state of the VR content according to the determination result in step S406. For example, the state transitions from the suspension state to the play state.

Next, in step S408, the notification unit 207 performs HMD display of displaying a notification screen according to the state of the VR content on the HMD 101 (display unit 107) of the user. Thereafter, this processing ends.

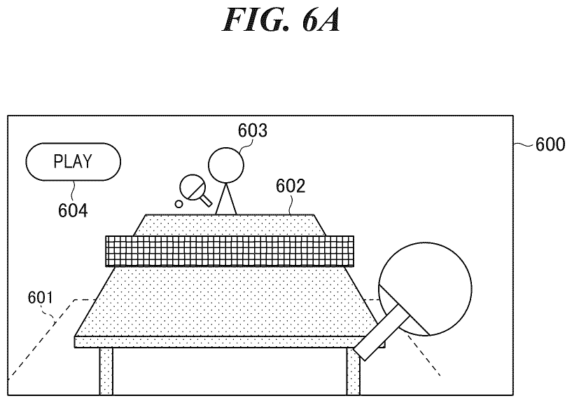

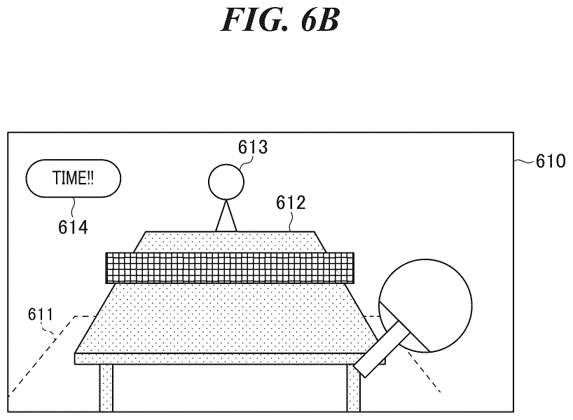

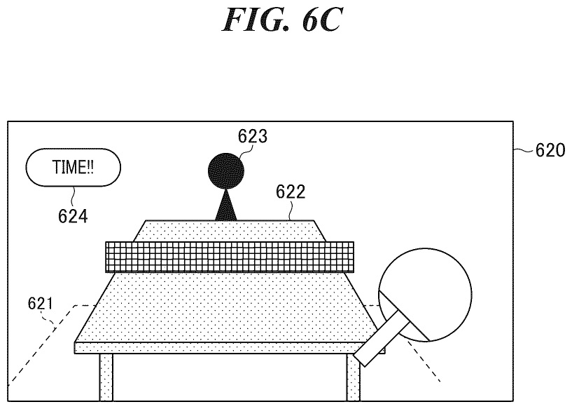

FIGS. 6A to 6C are examples of the HMD display according to the state of the VR content.

In FIGS. 6A to 6C, a user on the receiver side when playing in VR table tennis is referred to as a first user, and a user on the server side is referred to as a second user.

In FIG. 6A, an HMD display 600 is an HMD display example when the state of the VR content used by the user wearing the HMD 101 as the first user is in the play state.

On the HMD display 600 displayed on the display unit 107 of the first user, a play area 601, a virtual table tennis table 602, an avatar 603 of the second user who is an opponent, and a text 604 are displayed.

The text 604 is a user interface that presents a message to the first user according to the current state, and displays “PLAY” indicating that the state of the VR content is the play state. In this state, a ball is displayed on the hand of the avatar 603 of the second user, so that the second user can hit the ball to start serving.

An HMD display 610 of FIG. 6B is an HMD display example when the state of the VR content used by the user wearing the HMD 101 as the first user is in the suspension state. An HMD display 620 of FIG. 6C is an HMD display example when the stat of the VR content used by the user wearing the HMD 101 as the second user is in the suspension state.

On the HMD display 610 (FIG. 6B) displayed on the display unit 107 of the first user, a play area 611, a virtual table tennis table 612, an avatar 613 of the second user who is an opponent, and a text 614 are displayed.

The text 614 is a user interface that presents a message to the first user according to the current state, and displays “TIME!! ” indicating that the state of the VR content is the suspension state.

On the HMD display 620 (FIG. 6C) displayed on the display unit 107 of the second user, a play area 621, a virtual table tennis table 622, an avatar 623 of the first user who is an opponent, and a text 624 are displayed.

The text 624 is a user interface that presents a message to the second user according to the current state, and displays “TIME!! ” indicating that the state of the VR content is the suspension state. In this state, a ball is not displayed on the hand of the avatar 613 of the second user, so that the second user cannot start serving.

It should be noted that, in the present embodiment, the method for determining whether or not to permit a state transition in the two-dimensional space in the horizontal direction has been described with reference to FIGS. 3, 5A, and 5B, but a three-dimensional space including the vertical direction may be used. The shape of the play area may be changed according to the type of VR content.

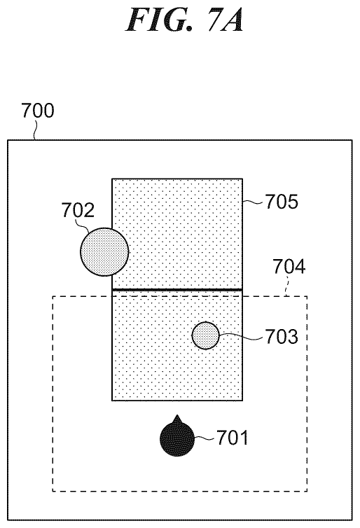

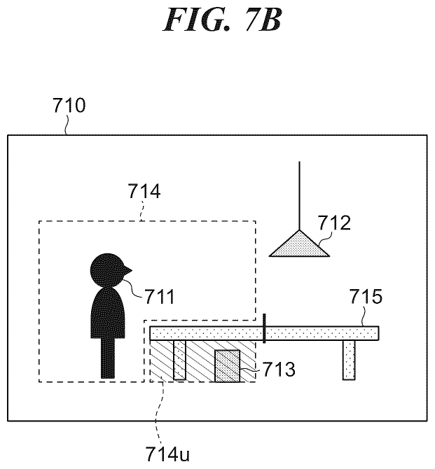

FIGS. 7A and 7B are diagrams for explaining a method for determining whether or not to permit a state transition using obstacle detection and posture information in the three-dimensional space including the vertical direction.

An image 700 of FIG. 7A is an image of the user viewed from above, and an image 710 of FIG. 7B is an image of the user viewed from right beside.

In FIGS. 7A and 7B, a user 701 and a user 711 are the same person. A lighting 702 and a lighting 712 are the same obstacle existing in the real space, and similarly, a trash box 703 and a trash box 713 are the same obstacle existing in the real space. A play area 704 and a play area 714 indicate the same area, and a table tennis table 705 and a table tennis table 715 are the same virtual object. The height of the play area 714 is preferably set such that the tip of a racket or the like gripped by the user 711 is within the play area 714 even when the user holds the racket or the external controller and raises his/her hand directly upward. Since the user 711 usually does not enter a space 714u under the virtual table tennis table 715 during the game play, the space 714u is excluded from the space of the play area 714. Therefore, the trash box 703 looks like being in the play area 704 when viewed from above as in the image 700, but the trash box 713 is not in the play area 714 when viewed from right beside as in the image 710. Thus, in the cases of FIGS. 7A and 7B, there is no obstacle in the play area, and the safety of the user can be secured even when the game is resumed. Therefore, the state transition determination unit 206 determines that the state of the VR content can transition, that is, the state transitions from the current suspension state to the play state. The user posture detection unit 204 may acquire posture information of the user 711 in three dimensions, and determine whether or not the user 711 squats below the table tennis table 715 from the posture information. At this time, when it is determined that the user 711 is squatting, the state transition determination unit 206 may determine that the user 711 is not ready for a serve from the opponent on the server side and cannot transition the state of the VR content.

As described above, according to the present embodiment, the user can safely and comfortably experience the VR content by using the obstacle information in the real space and the user information.

### Second Embodiment

The HMD 101 according to a second embodiment will be described with reference to FIGS. 8 to 11.

Since the HMD 101 according to the second embodiment has a hardware configuration similar to that of the HMD 101 according to the first embodiment, redundant description will be omitted.

The HMD 101 according to the first embodiment determines whether or not to permit the state of the VR content on the basis of the obstacle information in the real space and the position and orientation information and line-of-sight information of the user, and presents the determination result to the user. On the other hand, the HMD 101 according to the second embodiment uses one VR content by a plurality of persons at the same time, determines whether or not to permit the state of the VR content on the basis of the obstacle information in the real space of each user and the position and orientation information, line-of-sight information, and voice information of each user, and presents the determination result to the each user. Here, as an example, the operation of the HMD 101 according to the present embodiment will be described with a scene where a plurality of persons handle a work device in cooperation.

FIG. 8 is a block diagram showing a functional configuration according to the present embodiment of the HMD 101.

The HMD 101 includes, as a functional configuration, a play area acquisition unit 201, an obstacle detection unit 202, a user position detection unit 203, a user posture detection unit 204, a user's line-of-sight detection unit 205, a user voice detection unit 806, a state transition determination unit 206, and a notification unit 207. That is, in the HMD 101 in the present embodiment, the user voice detection unit 806 is added to the function (FIG. 2) of the HMD 101 according to the first embodiment.

The user voice detection unit 806 acquires a voice with a sound collection device such as a microphone attached to the HMD 101 worn by the user. It should be noted that, the user voice detection unit 806 may acquire a voice with an external sound collection device of the HMD 101 such as an intercom.

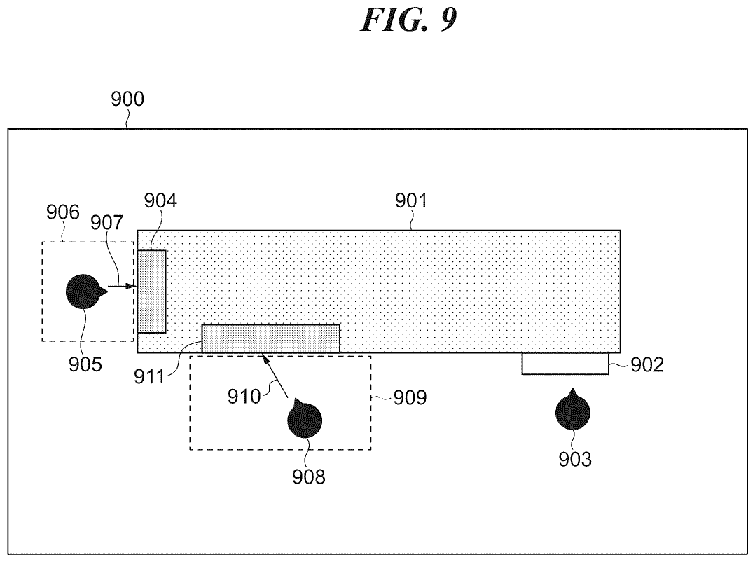

The operation of the HMD 101 at the time of work by a plurality of persons in the present embodiment will be described with reference to FIG. 9. An image 900 in FIG. 9 is an image of a device installation work viewed from above.

In FIG. 9, users 903, 905, and 908 and a work device 901 exist in the real space.

The work device 901 is a real space device in which an operation panel 902 is provided and work is simultaneously performed by the users 903, 905, and 908.

The user 903, the user 905, and the user 908 are users who operate the work device 901, and although not shown in FIG. 9, the users 905 and 908 wear the HMDs 101 and 101a, respectively, and perform work while receiving work support by the VR content. The user 903 does not wear the HMD. It should be noted that, since an HMD 101a is an information processing apparatus having the same hardware configuration and functional configuration as those of the HMD 101, thus “a” is added at the end of the numbering for the corresponding configuration, and redundant description will be omitted.

A play area 906 (first play area) is a play area of the user 905 wearing the HMD 101, and is acquired by the play area acquisition unit 201. A play area 909 (second play area) is a play area of the user 908 wearing the HMD 101a, and is acquired by a play area acquisition unit 201a. A work area 904 (first work area) is an area where the user 905 performs work, and a work area 911 (second work area) is an area where the user 908 performs work. The HMD 101 superimposes and displays a video of the real space viewed from the user 905 on the virtual space. Similarly, the HMD 101a superimposes and displays a video of the real space viewed from the user 908 on the virtual space. The user 903 operates the entire work device 901 using the operation panel 902.

It should be noted that, in the present embodiment, the work device 901, the work area 904, the work area 911, and the operation panel 902 are described as objects/areas existing in the real space, but may be objects/areas on the virtual space.

A line-of-sight direction 907 is a line-of-sight direction of the user 905 and is detected by the user's line-of-sight detection unit 205. Similarly, a line-of-sight direction 910 is a line-of-sight direction of the user 908 and is detected by a user's line-of-sight detection unit 205a.

The work in the work device 901 needs to be performed by the users 903, 905, and 908 in cooperation, and the user 903 (third user) operates the operation panel 902 in a state where the preparation of the users 905 and 908 are ready. The HMD 101 worn by the user 905, the HMD 101a worn by the user 908, and the operation panel 902 are communicably connected to each other. Accordingly, when the state transition determination unit 206 determines that the preparation of the users 905 and 908 are ready, the determination result is reflected in the interface of the operation panel 902.

Here, the state in which the preparation of the user 905 is ready means that conditions under which the user 905 can safely start work are satisfied. Specifically, it indicates that there is no obstacle detected by the obstacle detection unit 202 in the play area 906, that the user 905 is in the play area 906, and that the line-of-sight direction 907 is directed to the work area 904. In addition, presence or absence of a word specified in advance by the user 905, for example, utterance of “READY” may be included in the condition.

Similarly, the state in which the preparation of the user 908 is ready means that conditions under which the user 908 can safely start work are satisfied. Specifically, it indicates that there is no obstacle detected by an obstacle detection unit 202a in the play area 909, that the user 908 is in the play area 909, and that the line-of-sight direction 910 is directed to the work area 911. In addition, presence or absence of a word specified in advance by the user 908, for example, utterance of “READY” may be included in the condition. It should be noted that, the obstacle information (second obstacle information) generated by the obstacle detection unit 202a of the HMD 101a and the user information (second user information) such as the position, posture, and line-of-sight direction of the user 908 are acquired by the state transition determination unit 206 via the communication unit 109.

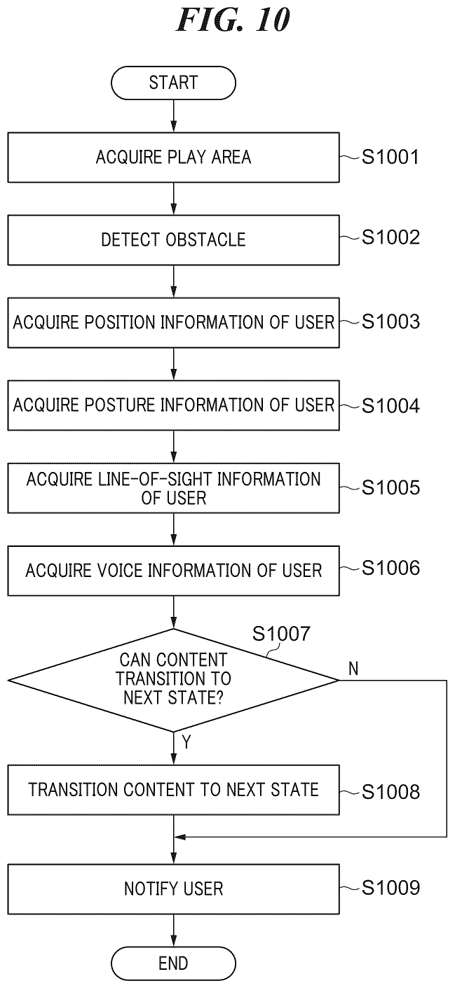

FIG. 10 is a flowchart of state transition control processing of VR content according to the second embodiment of the present invention. The processing shown in this flowchart is realized by the CPU 102 executing the information processing program according to the present embodiment. The execution timing of this processing is not limited. For example, it may be a timing at which any one of the users 905 and 908 activates VR content, or may be executed when the operation unit 108 detects a predetermined user operation. Hereinafter, the installation work of the work device 901 will be described as an example on the assumption that work support by VR content cannot be performed (hereinafter, referred to as a work impossible state).

Since the processing from step S1001 to step S1005 is similar to the processing from step S401 to step S405 shown in FIG. 4, the description thereof will be omitted.

In step S1006, the user voice detection unit 806 acquires the voice of the user.

It should be noted that the generation of the obstacle information and the acquisition of the position information, posture information, and line-of-sight information of the user 905, and the voice of the user 905 in steps S1002 to S1006 may be performed after step S1001 and before step S1007 described later. That is, the execution order thereof is not limited to the order shown in FIG. 10. Although not shown in the flowchart of FIG. 10, processing similar to steps S1002 to S1006 is executed by a CPU 102a of the HMD 101a, and obstacle information and various types of user information of the actual environment on the user 908 side are acquired.

Next, in step S1007, the state transition determination unit 206 determines whether or not to permit a state transition of VR content on basis of the obstacle information of the actual environment acquired in step S1002 and various types of user information acquired in steps S1003 to S1006. When it is determined that the state transition of the VR content cannot be performed (NO in step S1007), the processing proceeds to step S1009, and when it is determined that the state transition of the VR content can be performed (YES in step S1007), the processing proceeds to step S1008.

Here, a method for determining whether or not to permit a state transition of VR content according to the present embodiment will be described with reference to FIG. 9. As described above, when the preparation of the user 905 and the user 908 are ready, the state transition determination unit 206 determines that the state transition of the VR content can be performed. Specifically, when there is no obstacle in the play area 906, the user 905 is in the play area 906, the line-of-sight direction 907 is directed to the work area 904, and the user 905 has uttered the specified word, it is determined that the preparation of the user 905 is ready. Here, the specified word is not particularly limited, but “READY” or the like is exemplified.

In addition to the determination condition for determining that the preparation of the user 905 is ready, the user may perform a posture designated in advance, for example, a posture according to a pointing posture for safety confirmation. The determination condition may be stored in the ROM 103 in advance, or may be added or deleted by the user. The determination condition may be stored in the ROM 103 with a priority or may be selected by the user. That is, when it is determined that there is no obstacle in the play area 906 and at least one of the position, line of sight, posture, and voice of the user satisfies the determination condition for determining that the preparation of the user 905 is ready, the state transition determination unit 206 determines that the preparation of the user 905 is ready.

In the present embodiment, when the preparation of both users of the users 905 and 908 is ready, the state transition determination unit 206 determines that the state of the VR content can transition, and the processing proceeds to step S1008. On the other hand, when the preparation of any one of the users 905 and 908 is not ready, the state transition determination unit 206 determines that the state of the VR content cannot transition, and the processing proceeds to step S1009. That is, the state transition determination unit 206 acquires information indicating whether or not the preparation of the user 908 is ready from the HMD 101a, and determines whether or not to permit a state transition of VR content.

Next, in step S1008, the state transition determination unit 206 transitions the state of the VR content according to the determination result in step S1007. For example, the state transitions from the work impossible state to a state in which work support by the VR content can be performed (hereinafter, referred to as a workable state).

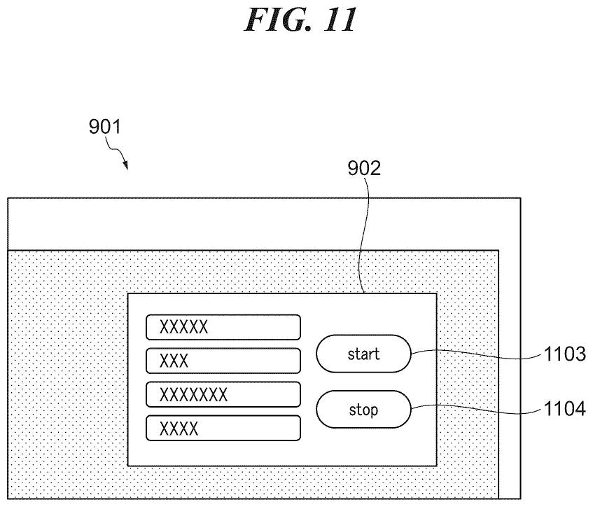

Next, in step S1009, the notification unit 207 transmits information indicating the state of the VR content to the operation panel 902, and causes the operation panel 902 to display a notification screen for the user 903 according to the received information. Hereinafter, the operation of the notification unit 207 and the operation panel 902 in step S1009 will be described with reference to FIGS. 9 and 11.

FIG. 11 is an example of a notification screen displayed on the operation panel 902 visually recognized by the user 903.

As shown in FIG. 11, a notification screen including a start button 1103 and a stop button 1104 is displayed on the operation panel 902 of the work device 901.

The start button 1103 is a user interface for activating the work device 901, and the stop button 1104 is a user interface for stopping the work device 901.

When the state transition determination unit 206 causes the state of the VR content to transition to the workable state in step S1008, the notification unit 207 transmits information indicating that the state of the VR content is in the workable state to the operation panel 902 in step S1009. When receiving this information, the operation panel 902 sets the start button 1103 to the active state (user-selectable state).

On the other hand, when the state transition determination unit 206 causes the state of the VR content to be maintained in the work impossible state in step S1008, the notification unit 207 transmits information indicating that the state of the VR content is maintained in the work impossible state to the operation panel 902 in step S1009. When receiving this information, the operation panel 902 sets the start button 1103 to the inactive state (user-non-selectable state).

At this time, the operation panel 902 may change the display method of the start button 1103 between the active state and the inactive state. When the start button 1103 is in the active state, the user 903 can start the work device 901 by pressing the start button 1103.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-022785, filed Feb. 19, 2024 which is hereby incorporated by reference herein in its entirety.

What is claimed is:

1. An information processing apparatus displaying a virtual space on a head mounted display worn by a user, comprising:
one or more processors and/or circuitry configured to:
acquire a play area of the user as a first play area;
detect an obstacle in a real space in the first play area and generate obstacle information indicating a positional relationship between the detected obstacle and the first play area;
acquire user information from the user;
execute state transition determination of determining whether content to be displayed in the virtual space can transition to a next state on basis of the obstacle information and the user information; and
make a notification according to a result of the state transition determination.

2. The information processing apparatus according to claim 1, wherein the user information includes at least one of a position, line-of-sight direction, posture, or voice of the user.

3. The information processing apparatus according to claim 2, wherein the state transition determination is a determination as to whether or not to permit a state transition of the content according to whether or not a position of the obstacle exists in the first play area.

4. The information processing apparatus according to claim 2, wherein the state transition determination is a determination as to whether or not to permit a state transition of the content according to whether or not the position of the user is included in the first play area.

5. The information processing apparatus according to claim 2, wherein the state transition determination is a determination as to whether or not to permit a state transition of the content according to whether or not at least one of the position and posture of the user is stationary in the first play area.

6. The information processing apparatus according to claim 2, wherein the state transition determination is a determination as to whether or not to permit a state transition of the content according to whether or not the line of sight of the user is directed to a target designated in advance in the virtual space.

7. The information processing apparatus according to claim 6, wherein the state transition determination is a determination of a target to which the line of sight of the user is directed based on the line-of-sight direction of the user.

8. The information processing apparatus according to claim 6, wherein the state transition determination is a determination of a target to which the line of sight of the user is directed based on the line-of-sight direction of the user and a gaze time thereof.

9. The information processing apparatus according to claim 2, wherein the state transition determination is a determination as to whether or not to permit a state transition of the content according to whether or not the posture of the user conforms to a posture designated in advance.

10. The information processing apparatus according to claim 2, wherein the state transition determination is a determination as to whether or not to permit a state transition of the content according to whether or not a word designated in advance is included in the voice of the user.

11. The information processing apparatus according to claim 1, wherein the notification is display of a message to the user in the virtual space according to the result of the state transition determination.

12. The information processing apparatus according to claim 2, further comprising a communication unit configured to communicate with another information processing apparatus that displays the virtual space on another head mounted display worn by another user,
wherein the another information processing apparatus comprises one or more processors and/or circuitry configured to:
acquire a play area of the another user as a second play area; and
detect an obstacle in a real space in the second play area and generate second obstacle information indicating a positional relationship between the detected obstacle and the play area; and
acquire second user information from the another user,
the state transition determination is a determination of determining whether the content can transition to a next state according to the second obstacle information and the second user information acquired from the another information processing apparatus by the communication unit, the obstacle information, and the user information.

13. The information processing apparatus according to claim 12, wherein the second user information includes at least one of a position, line-of-sight direction, posture, and voice of the another user.

14. The information processing apparatus according to claim 13, wherein the state transition determination is a determination as to whether or not to permit a state transition of the content according to whether or not a word designated in advance is included in the voice of the user and the voice of the another user.

15. The information processing apparatus according to claim 12, wherein the communication unit is configured to further communicable with an operation panel of a work device in a real space operated by a third user, and
the notification sets a start button, which is displayed on the operation panel for the third user to activate the work device, to one of an active state and an inactive state according to the result of the state transition determination.

16. The information processing apparatus according to claim 15, wherein the head mounted display superimposes and displays a video of a real space viewed from the user on the virtual space,
the another head mounted display superimposes and displays a video of a real space viewed from the another user on the virtual space, and
the state transition determination is a determination as to whether or not to permit a state transition of the content according to whether or not the line of sight of the user is directed to a first work area in the work device and the line of sight of the another user is directed to a second work area in the work device.

17. The information processing apparatus according to claim 16, wherein the state transition determination is a determination of a target to which the lines of sight of the user and the another user are directed based on the line-of-sight directions of the user and the another user.

18. The information processing apparatus according to claim 16, wherein the state transition determination is a determination of a target to which the lines of sight of the user and the another user are directed based on the line-of-sight directions of the user and the another user and gaze times thereof.

19. The information processing apparatus according to claim 1, wherein the obstacle is detected in a two-dimensional space in a horizontal direction.

20. The information processing apparatus according to claim 1, wherein the obstacle is detected in a three-dimensional space in a horizontal direction and a vertical direction.

21. The information processing apparatus according to claim 20, wherein the obstacle is searched for in a space excluding a space that the user does not enter from the play area.

22. An information processing method of an information processing apparatus that displays a virtual space on a head mounted display worn by a user,
wherein the method comprises:
a play area acquisition step of acquiring a play area of the user as a first play area;
an obstacle detection step of detecting an obstacle in a real space in the first play area and generating obstacle information indicating a positional relationship between the detected obstacle and the first play area;
a user information acquisition step of acquiring user information from the user;
a state transition determination step of determining whether content to be displayed in the virtual space can transition to a next state on basis of the obstacle information and the user information; and
a notification step of making a notification according to a result of the state transition determination step.

23. A non-transitory computer readable storage medium storing a program that causes a computer to execute an information processing method of an information processing apparatus that displays a virtual space on a head mounted display worn by a user,
wherein the method comprises:
a play area acquisition step of acquiring a play area of the user as a first play area;
an obstacle detection step of detecting an obstacle in a real space in the first play area and generating obstacle information indicating a positional relationship between the detected obstacle and the first play area;
a user information acquisition step of acquiring user information from the user;
a state transition determination step of determining whether content to be displayed in the virtual space can transition to a next state on basis of the obstacle information and the user information; and
a notification step of making a notification according to a result of the state transition determination step.
